(19) United States
(12) Patent Application Publication
(10) Pub. No.: US 2012/0054605 A1
(43) Pub. Date: Mar. 1, 2012

(54) ELECTRONIC DOCUMENT CONVERSION SYSTEM

(75) Inventor: Kyle M. Kestell, Minneapolis, MN (US)

(73) Assignee: HILLCREST PUBLISHING GROUP, INC., Minneapolis, MN (US)

(21) Appl. No.: 12/872,719

(22) Filed: Aug. 31, 2010

(51) Int. Cl. G06F 17/24; G06F 17/00

(52) U.S. Cl. 715/256; 715/255

(57) ABSTRACT

A system, and techniques used therein, for creating electronic documents, such as electronic books. The system involves a process whereby an original document's content is converted from one specific electronic format into a more comprehensive and compatible electronic format. Such process involves dividing the content of the original document into a sequence of blocks, which can thereafter be converted to any of a number of electronic formats. The blocks can also be tagged so as to impart semantic structure of the original document's text thereon, enabling a more complex and accurate conversion of the original document, and a more comprehensive and efficient mechanism for reviewing the converted document.

### BACKGROUND

1. Field of the Invention

The present invention relates to a system, and techniques used therein, for creating electronic documents, and more particularly, for converting an original document of specific electronic format to a document of more comprehensive and compatible format.

2. Description of the Related Prior Art

There are a variety of known techniques for creating electronic documents, such as electronic books. Regarding these creation techniques, it is often desirable not only to convert an original document from its initial file format to a further desired file format in order to be compatible with a select reader device platform, but also to maintain the content of the converted document so that it matches or closely resembles its original representation, e.g., as provided in its physically published form. An example of converting book content using such techniques may involve an Adobe Acrobat (.pdf) or Microsoft Word (.word) document being converted to any of a variety of known electronic book file formats, such as Mobi or ePub.

However, in many known techniques, the process only enables conversion to one select format.

In converting book content, this can be particularly troublesome as not all electronic book platforms use the same file format. In addition, when an electronic book document is converted from its original format to any such select format, one often ends up with a low-quality resultant. Such is the case due to lack of semantic understanding on the part of the algorithm that is used in the conversion process. For example, such algorithms are often configured to correctly identify the size and proximity of the text on a page, yet lack the capability of being able to distinguish the different text of the book, e.g., not being able to distinguish whether the text represents a chapter title or another similarly-styled piece of text. Therefore, following such conversion process, additional configuration of the text needs to take place, generally by a human editor, leading to higher production costs that are ultimately passed along to the customer.

The present invention addresses these and other problems.

### SUMMARY OF THE INVENTION

Embodiments of the invention provide a system, and techniques used therein, for creating electronic documents. In certain embodiments, the documents created involve electronic books, and the system involves a process whereby the book's content is converted from one specific electronic format into a more comprehensive and compatible electronic format. Such process involves dividing the content of the original electronic book document into a sequence of blocks, which can thereafter be converted to any of a number of electronic book file formats.

Additionally in certain embodiments, the blocks can be tagged so as to impart the semantic structure of the book's text thereon. Such semantic understanding enables a complex and accurate conversion of the original document whereby during its conversion, any of a variety of different semantic themes can be selectively chosen for the converted document. In addition, such tagged blocks enable review of the converted document to be performed in a more comprehensive and efficient manner as the blocks can be tagged with comments.

### DESCRIPTION OF THE DRAWINGS

FIG. 1 is a block diagram of parties and their involvement in relation to an electronic document conversion process in accordance with certain embodiments of the invention.

FIG. 2 is a flowchart of steps involved in an electronic document conversion process in accordance with certain embodiments of the invention.

FIG. 3 shows a displayed document with sections of its content divided into exemplary blocks depicted on a computer screen in accordance with certain embodiments of the invention.

FIG. 4A shows a displayed document with one exemplary semantic theme depicted on a computer screen in accordance with certain embodiments of the invention.

FIG. 4B shows a displayed document with another exemplary semantic theme depicted on a computer screen in accordance with certain embodiments of the invention.

FIG. 5 shows a displayed document with a text annotation window open on a computer screen in accordance with certain embodiments of the invention.

### DETAILED DESCRIPTION

The following detailed description should be read with reference to the drawings, in which like elements in different drawings are numbered identically. The drawings depict selected embodiments and are not intended to limit the scope of the invention. It will be understood that embodiments shown in the drawings and described below are merely for illustrative purposes, and are not intended to limit the scope of the invention as defined in the claims.

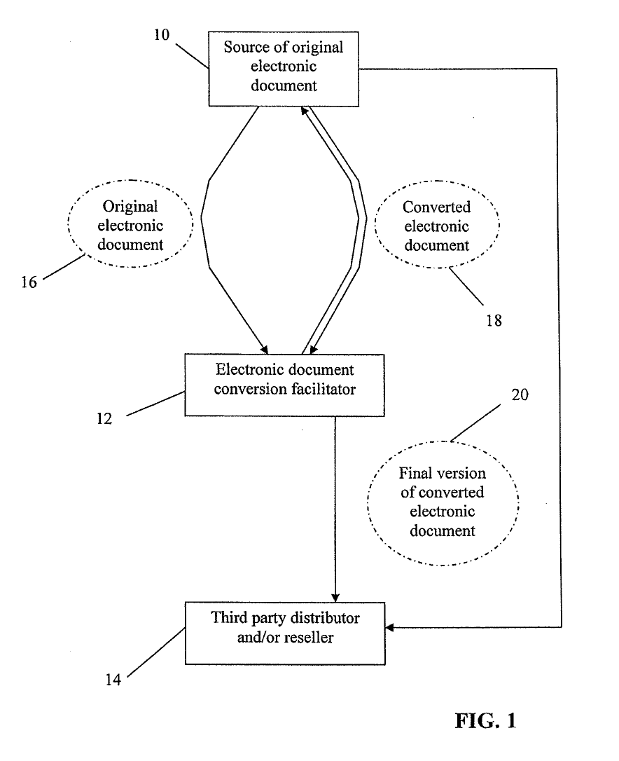

In use, the system of the present invention involves a variety of steps that are performed in creating an electronic document. In certain embodiments, the electronic document stems from a book; however, the invention should not be limited to such. For instance, the created electronic document can stem from any of a variety of written documents that have been previously published or are now intended for publication. As such, in creating an electronic document of such written document, the document is further converted to any of a number of electronic book file formats so as to ready it for commercialization via third party distributors and/or retailers. Such relationship is depicted in and described with reference to FIG. 1.

In particular, FIG. 1 is a block diagram of parties and their general involvement in relation to an electronic document conversion process in accordance with certain embodiments of the invention. It should be appreciated that the involvement of the parties of FIG. 1 is depicted at high level, with the parties including a source 10 (such as an author) of an original electronic document 16, a facilitator 12 of the electronic document conversion, and a third party distributor and/or reseller 14. While only three parties are shown in FIG. 1, it should be appreciated that more parties may be involved, not only with respect to conversion of the original electronic document 16, but also subsequently with respect to commercialization of a converted document final version 20. For example, one or more steps involved in the document conversion process may be contracted out to third party companies, e.g., with respect to editing the converted electronic document 18. Further, regarding commercialization of the converted document final version 20, it should be appreciated that additional parties may be involved in the commerce chain besides the distributor and/or reseller 14. Finally, it should be understood that the role of the third party distributor and/or reseller 14 may alternatively be performed by one or more of the source 10 and the conversion facilitator 12.

As depicted in FIG. 1, the source 10 provides the original electronic document 16 to the conversion facilitator 12. In certain embodiments, the original electronic document 16 includes the entire textual content of a written document, and in certain embodiments, the source 10 is the author(s) of such written document. The written document, in certain embodiments, stems from a book; however, as described above, the invention should not be limited to such. In certain embodiments, the content of the original document 16 is provided in a semantic theme that matches its representation in physically-published form; however, the content may just as well be provided in a standard textual form with no or limited resemblance to a physically-published representation. The original electronic document 16 provided by the source 10 to the facilitator 12 is of a specific file format. For example, in certain embodiments, the provided document 16 may be an Adobe Acrobat (.pdf) or Microsoft Word (.word) document.

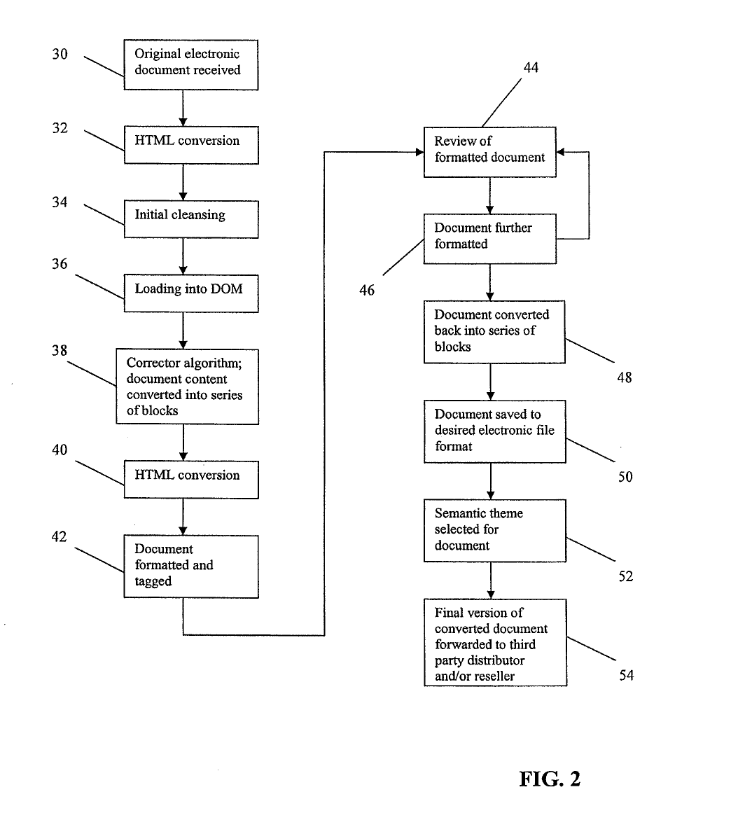

Upon receiving the original electronic document 16 from the source 10, the conversion facilitator 12 proceeds in converting the document 16 using a variety of steps. Such steps are described in greater detail below with reference to FIG. 2. However, with respect to FIG. 1, it should be understood that an initial series of steps is performed by the conversion facilitator 12 in forming the converted electronic document 18 from the original document 16. It is to be understood that when the facilitator 12 is described herein to perform a series of steps in the conversion process, the steps may be performed by one or more of mechanisms, employees, affiliates, or agents of the facilitator 12.

Following such initial series of steps, the converted electronic document 18 is forwarded to the source 10 for review/approval. Such review by the source 10 of the converted electronic document 18 will in most cases result in further modifications needing to be made thereto before such document 18 can be finalized. Accordingly, following such review by the source 10, additional steps are performed by the conversion facilitator 12 in making corresponding modifications to the converted electronic document 18. It should be understood that such review and corresponding modification steps may be repeated one or more times between the source 10 and the conversion facilitator 12 before the converted document 18 is approved.

Following completion of such back and forth between the source 10 and the conversion facilitator 12, whereby the converted document 18 is ultimately approved by the source 10, final steps are performed by the facilitator 12 to convert the document 18 to a desirable file format. As described above, in cases in which the created electronic document stems from a book, such desirable file format for the converted document 18 may vary depending on the type of electronic book platform that will be utilized with the document 18. For example, in certain embodiments, the converted document 18 may be converted to a Mobi file format or an ePub file format, so as to be used with platforms supported by a Kindle device or an IPad device, respectively.

As will be further detailed with reference to FIG. 2, the conversion process of the invention is configured such that the converted document 18 is convertible to any of a wide variety of file formats. Accordingly, the file format of the created electronic document, i.e., the converted electronic document final version 20, can be selectively adapted as desired. Consequently, a plurality of final versions 20, each having differing electronic file formats, can be produced from the converted electronic document 18 and then commercialized, e.g., by further forwarding the document final versions 20 to the third party distributor and/or reseller 14. As shown in FIG. 1, in certain embodiments, the source 10 can provide the final version 20 directly to the third party distributor and/or reseller for subsequent commercialization. Alternatively, as further illustrated, the conversion facilitator 12 can work as an agent of the source 10, utilizing contacts it has established with certain of the distributors and/or resellers 14.

As described above, the electronic document conversion process provided by its facilitator 12 involves a number of steps. FIG. 2 is a flowchart of such steps involved in the conversion process in accordance with certain embodiments of the invention. To that end, the first step 30 shown in FIG. 2 is not related with the conversion process, but instead involves the original electronic document 16 being provided to the conversion facilitator 12 by the source 10. Following this step, the facilitator 12 is in possession of the original document 16 and can proceed with steps of the conversion process. Likewise, the final step 54 shown in FIG. 2 involves the electronic document created, i.e., the converted document final version 20, by the process. In turn, such final version 20 can be passed along to the third party distributor and/or reseller 14.

Regarding step 30, and in light of that described with respect to FIG. 1, the original electronic document 16 provided by the source 10 to the conversion facilitator 12 is of one specific file format. The file format of such original document 16 in many cases depends on the word processing or other systems used in the document's creation. It should be appreciated that Adobe Acrobat (from which .pdf files are created) and Microsoft Word (from which .word files are created) are two systems widely used by the general public in creating written documents. As such, in certain embodiments, the original document 16 may be provided to the conversion facilitator 12 in one of these files formats; however, the invention should not be limited to such. Instead, the document creation system of the invention is configured to function with files of these formats as well as files created using other document processing systems.

The conversion system embodied herein functions under a digital text platform, wherein its conversion functions as applicable to an input original electronic document are fully automated. As described above with reference to FIG. 1, there are series of steps the system performs in its conversion process. The initial series of steps involves conversion of the original document 16 to a first iteration of the converted document 18.

In certain embodiments, after the facilitator 12 receives the original document 16 from the source 10, the content of the document 16 is converted to HTML (HyperText Markup Language), as referenced in step 32. Such HTML conversion is often used as a means for creating structured documents by denoting certain characteristics of the text, such as its size and general proximity. However, HTML conversions are not without certain limitations. For example, such conversions have been found to be lacking with respect to their ability to distinguish particular semantics within the text's content (in differentiating different sections of the text from each another), such as a chapter title from other similarly-styled pieces of text. Regardless, initially converting the content of the original document 16 to HTML format provides a base platform from which the text can be further distinguished using the embodied conversion system.

Following step 32, the input markup of the HTML document is initially cleaned in step 34 to prepare its content for further differentiation. For example, such cleansing may involve addressing any conversion errors found in the HTML document. In certain embodiments, this cleansing step is automated, and can be performed as a complementary task to the HTML conversion of step 32. Subsequently, in certain embodiments, the cleaned markup is loaded into an in-memory DOM (Document Object Model) in step 36. Such DOM provides a structured, object-oriented representation of the individual elements and content of the cleansed document with methods for retrieving and setting the properties of those objects.

Following formation of the DOM in step 36, the content of the DOM is passed in step 38 through a corrector algorithm of the conversion system. In so doing, the content of the DOM is divided into parts so that each part corresponds with one of a sequence or series of separate blocks. In certain embodiments, the blocks are assigned according to breaks in the document's content. Accordingly, a paragraph in the content is assigned a block, as is a chapter title, as is an image if applicable. Regarding the individual blocks, they can be thought as distinct pieces of content of the electronic document which, when successively stacked one upon another, make up the entire content of the document. To that end, it should be understood that this plurality of assigned blocks could be thought of as representing the atomic structure of the document that is created via the conversion system.

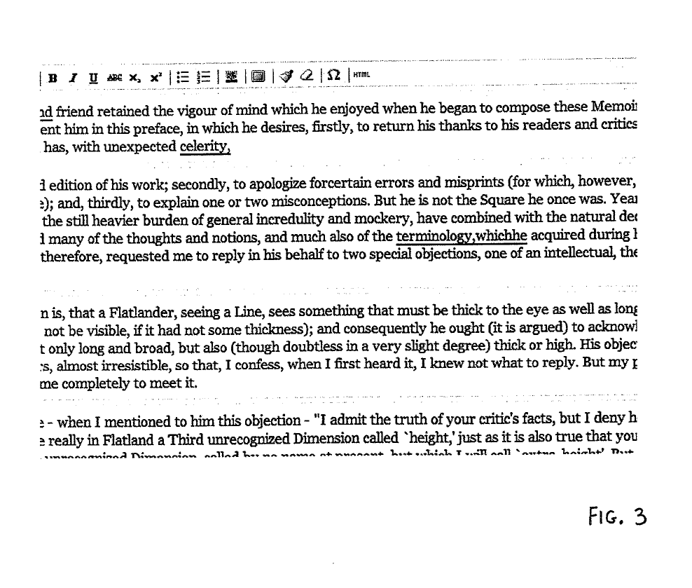

In certain embodiments, each block is formed as a plurality of tokens with a separate token representing each word, space, and even punctuation of the content part linked to the block. As such, each block has a continuous token stream derived from the content of the block. Accordingly, based on the tokens, the blocks can be differentiated by type and content, wherein the content within each block and between separate blocks can be differentiated. Consequently, after the blocks have been generated, perceived errors are identified in the document, e.g., involving the content within the blocks and the contents of multiple blocks as viewed in relation to each other. In certain embodiments, at least two error types are identified, one type which is perceived as an apparent error that is relatively easy to address and another type which is perceived as an error which is not so easily fixed. In certain embodiments, the at least two error types are distinguished, such as by using separate font colors or markings for each type. For illustration purposes, FIG. 3 shows a displayed document with sections of its content divided into exemplary blocks depicted on a computer screen in accordance with certain embodiments of the invention. As shown, certain errors are identified in the displayed blocks of content, e.g., by underlining in red. As should be appreciated, these errors are of the type relatively easy to address.

Following step 38 in which the blocks are conformed to the document's content, and perceived errors are identified within the content of the blocks and/or between the contents of multiple blocks, the collection of blocks in step 40 is sent to a web browser, at which an HTML document is correspondingly created for the blocks. In turn, the HTML representation of the blocks is relayed to a formatter charged with tasks of addressing the identified errors and further tagging the blocks in step 42. In certain embodiments, the role of the formatter is directly provided, or alternatively overseen, by a person employed by, or serving as an agent of, the conversion process facilitator 12. As such, in certain embodiments, when the formatting is overseen by such person, the rest of the process is computer driven via processor means.

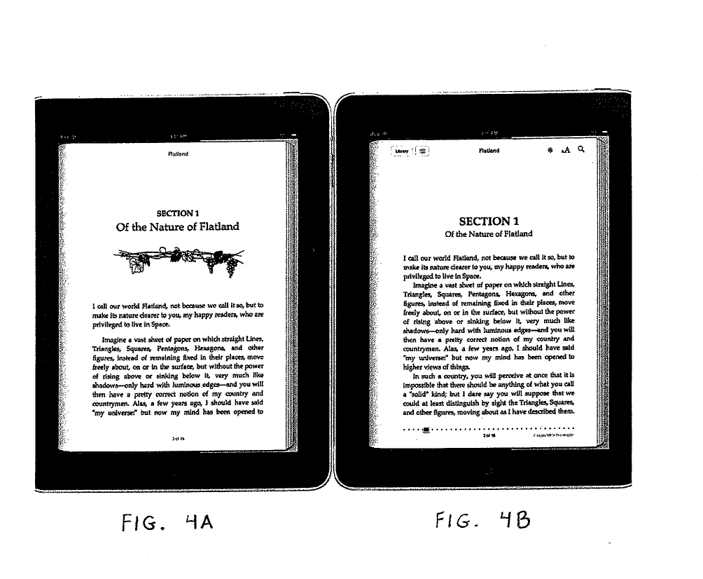

Tagging the blocks serves two primary purposes. First, by tagging the blocks, the semantic structure of the book's text, particularly portions of its metadata that is typically obscure, is imparted onto the blocks. Such semantic understanding that is gained via tagging enables the content of the blocks, and specifically, the text metadata, to be convertible to selected themes of choice. In particular, a theme is a set of style rules which define how the textual content will physically appear. For example, a theme may define one or more characteristics of the textual content, such as font sizes, text alignments, colors, and the like. Thus, as described above, upon the blocks being tagged, the particular style rules of the blocked text are qualitatively identified as to its theme characteristics. In turn, such characteristics for the text can be readily modifiable to any of a variety of differing themes as desired. FIGS. 4A and 4B show displayed documents, each with a different exemplary semantic theme, depicted on a computer screen in accordance with certain embodiments of the invention.

Second, in tagging the blocks, annotations and/or comments can be provided with respect to the blocks. Such functionality is particularly advantageous to the formatter when addressing the errors identified within the blocks. For example, upon coming across an error type that has been identified but not easily fixed, guidance on the issue may be needed from the source 10 of the original document 12. Accordingly, in such a scenario, the formatter in step 42 can address a number of the identified errors (those that are relatively easy to address) and further denotes certain of the blocks, via annotations, with respect to others of the errors (that are not so easily fixed), requesting feedback from the source 10 for the same. In particular, such annotations are a complementary feature of the blocks upon being tagged. In certain embodiments, a pop-up window can be opened from such tagged blocks for facilitating a means of interaction between the formatter and the source 10. Upon the formatter completing the initial revision and tagging processes, the resulting document, i.e., the converted document 18 of FIG. 1, is forwarded to the source 10 in step 44 for further review/approval.

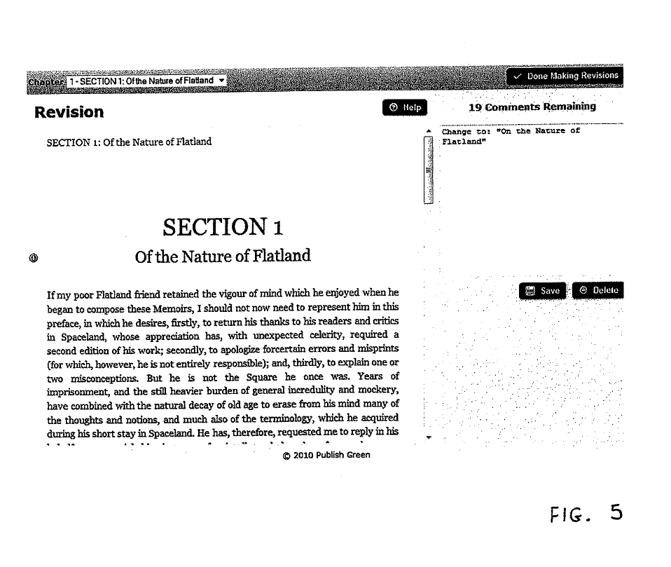

In reviewing the converted document 18, the source 10 is drawn to pay particular attention to the tagged blocks provided with annotations from the formatter, thereby making the review process more efficient. As such, the formatter's questions/comments with respect to the certain of the tagged blocks can be easily identified, and subsequently addressed, by the source 10. In turn, the converted document 18 is forwarded back to the formatter, who in step 46 addresses the remainder of perceived errors with respect to the blocks. To that end, FIG. 5 shows a displayed document with a text annotation window open on a computer screen in accordance with certain embodiments of the invention. As described above, back and forth reworking of the converted document 18 between the source 10 and the formatter 12 may involve one or more cycles of steps 44 and 46.

Upon the final edits being made to the converted document 18 and the document 18 being approved by the source 12, the HTML document involving the tagged blocks is converted back into the series of blocks that is subsequently saved to a database in step 48. Consequently, the document 18 as represented in block form is adaptable and can be saved to any of a variety of electronic document file formats. This is made possible through the blocks of the document 18, and the further differentiation of the blocks into token streams. Such token streams enable the text thereof to be of a reflowable configuration, such that the text can be readily reformatted in relation to the intended electronic document platform. As such, in step 50, the document is saved to a desirable electronic file format based on the electronic document platform it is intended to be compatible with. In certain embodiments, such electronic file format may be a Mobi file format or an ePub file format, so as to be used with platforms supported by a Kindle device or an IPad device, respectively; however, the invention should not be limited to such.

Further, in step 52, the semantic theme for the document is selected such that its style aligns with the document's visual representation in its physically published form. This is made possible through the blocks of the document still being tagged with respect to its textual characteristics, or theme. Such tagging, as described above, imparts a semantic understanding on the blocks so the textual characteristics of the document's content can be collectively modified (or modified as desired) so as to align with an intended style or semantic theme for the created document, i.e., the converted document final version 20. Alternatively, if there is no style or theme in published form to which the document can be aligned with, a stock theme can be selected for the content of the book such that it will be displayed in a generally pleasing fashion. Following step 52, the final version 20, is now arrived at and ready for commercialization. As such, in step 54, the final version 20 is forwarded to the third party distributor and/or reseller 14.

It will be appreciated the embodiments of the present invention can take many forms. The true essence and spirit of these embodiments of the invention are defined in the appended claims, and it is not intended the embodiment of the invention presented herein should limit the scope thereof.

What is claimed is:

1. A system used for creating an electronic document, whereby an original document is converted from an initial file format to a further file format, the system comprising a conversion system adapted to divide content of the original document into a sequence of blocks, each of the blocks differentiated corresponding to content portion therein, the content of the original document in such collectively blocked and further differentiated form enabling conversion of the original document to the further file format.

2. The system of claim 1 wherein the electronic document comprises an electronic book, and wherein the original document comprises a book in the initial file format.

3. The system of claim 2 wherein the further file format is dependent on type of electronic book platform for the electronic document.

4. The system of claim 1 wherein the content portion of each block is differentiated via a plurality of tokens.

5. The system of claim 4 wherein each of the plurality of tokens of each block represents one of a separate word, space, or punctuation of the content portion of the block.

6. The system of claim 4 wherein the plurality of tokens of each block represents a continuous token stream of the content portion of the block.

7. The system of claim 6 wherein the continuous token stream of the content portion of each block taken collectively comprises a reflowable configuration for the content of the original document, wherein said reflowable configuration permits reformatting of the original document to the further file format.

8. The system of claim 1 wherein each block is tagged with semantic structure of the content portion of the block, wherein the tagged semantic structure of the content portion of each block is imparted on the block.

9. The system of claim 8 wherein the semantic structure comprises a select theme, wherein the select theme of each block comprises a set of style rules defining the physical appearance of textual content of the block.

10. The system of claim 9 wherein the style rules comprise definition of one or more characteristics of the textual content of each block.

11. The system of claim 10 wherein the one or more characteristics comprise font sizes, alignments, and colors.

12. The system of claim 9 wherein the imparted set of style rules of the select theme of the content portion of each block enables the blocks to be configurable to any of a number of differing themes, wherein the differing themes each comprise style rules distinct from the select theme.

13. The system of claim 12 wherein the blocks are collectively configurable to any of the number of differing themes.

14. The system of claim 8 wherein the tagged blocks each comprise a selectively openable window as a means of interaction between a facilitator of the conversion system and a source of the original document.

15. A system used for creating an electronic document, whereby an original document is converted from an initial file to a further file, the system comprising a conversion system adapted to divide content of the original document into a sequence of blocks, each of the blocks tagged with semantic structure of content portion of the block, the tagged semantic structure of the content portion of each block being imparted on the block, the semantic structure comprising a select theme, the imparted select theme of the content portion of each block enabling the blocks to be configurable to any of a number of differing themes for the content portions of the blocks.

16. The system of claim 15 wherein the select theme of each block comprises a set of style rules defining the physical appearance of textual content of the block.

17. The system of claim 16 wherein the style rules comprise definition of one or more of characteristics of the textual content of each block.

18. The system of claim 15 wherein the differing themes each comprise style rules distinct from the select theme.

19. The system of claim 15 wherein the blocks are collectively configurable to any of the number of differing themes.

20. The system of claim 15 wherein the tagged blocks each comprise a selectively openable window as a means of interaction between a facilitator of the conversion system and a source of the original document.

21. A system used for creating an electronic document, whereby an original document is converted from an initial file format to a further file format, the system comprising a conversion system adapted to divide content of the written document into a sequence of blocks, wherein
each of the blocks is tagged with semantic structure of content portion of the block, the tagged semantic structure of the content portion of each block being imparted on the block, the semantic structure comprising a select theme, the imparted select theme of the content portion of each block enabling the blocks to be configurable to any of a number of differing themes for the content portions of the blocks, and
each of the blocks is differentiated corresponding to the content portion of the block, the content of the original document in such collectively blocked and further differentiated form enabling conversion of the original document to the further file format.

22. The system of claim 21 wherein the content portion of each block is differentiated via a plurality of tokens.

23. The system of claim 22 wherein the plurality of tokens of each block represents a continuous token stream of the content portion of the block.

24. The system of claim 23 wherein the continuous token stream of the content portion of each block taken collectively comprises a reflowable configuration for the content of the original document, wherein said reflowable configuration permits reformatting of the original document to the further file format.

25. The system of claim 21 wherein the select theme of each block comprises a set of style rules defining the physical appearance of textual content of the block.

26. The system of claim 25 wherein the style rules comprise definition of one or more of characteristics of the textual content of each block.

27. The system of claim 21 wherein the differing themes each comprise style rules distinct from the select theme.

28. The system of claim 21 wherein the blocks are collectively configurable to any of the number of differing themes.

29. The system of claim 21 wherein the tagged blocks each comprise a selectively openable window as a means of interaction between a facilitator of the conversion system and a source of the original document.
